(19) United States
(12) Patent Application Publication
(10) Pub. No.: US 2015/0169944 A1
(43) Pub. Date: Jun. 18, 2015

(54) IMAGE EVALUATION APPARATUS, IMAGE EVALUATION METHOD, AND NON-TRANSITORY COMPUTER READABLE MEDIUM

(71) Applicant: FUJIFILM Corporation, Tokyo (JP)

(72) Inventors: Yukita GOTOHDA, Tokyo (JP); Kei YAMAJI, Tokyo (JP)

(21) Appl. No.: 14/557,909

(22) Filed: Dec. 2, 2014

(30) Foreign Application Priority Data
Dec. 13, 2013 (JP) 2013-257541

(51) Int. Cl. G06K 9/00; H04N 1/21; G06F 3/0483; G06K 9/62

(52) U.S. Cl. CPC G06K 9/00288; G06K 9/00228; G06K 9/6218; H04N 1/2179; G06F 3/0483; G06K 2009/00328

(57) ABSTRACT

A plurality of images are grouped using imaging date and time in supplementary information of an image. The number of images included in each group becomes importance, and images belonging to a group of which the importance is equal to or more than a threshold are evaluation targets in an image evaluation apparatus. An image file representing an image that is an evaluation target is given to the image evaluation apparatus, and image evaluation is performed. Automatic layout of an electronic album is performed using an image of which the image evaluation is high. Since all images stored in a recording medium carried by a user are not image evaluation targets, but images considered to be important become image evaluation targets, a time according to the image evaluation is shortened and a waiting time for the user is also shortened.

### CROSS-REFERENCE TO RELATED APPLICATIONS

The present application claims priority under 35 U.S.C. §119 to Japanese Patent Application No. 2013-257541, filed on Dec. 13, 2013, all of which are hereby expressly incorporated by reference into the present application.

### BACKGROUND OF THE INVENTION

1. Field of the Invention

The present invention relates to an image evaluation apparatus, an image evaluation method, and a non-transitory computer readable medium.

2. Description of the Related Art

The number of captured images has greatly increased due to the spread of digital cameras or smartphones. When a photo product such as a photo book, prints, or an electronic album is created from a large number of images, it is difficult for a user to select and arrange desired images. Therefore, when an image is read, analysis of the image is performed, an evaluation value of the image is calculated based on a result of the analysis, and selection and arrangement of images is performed based on results of the calculations in an image processing device (JP2013-33453A).

### SUMMARY OF THE INVENTION

However, since an amount of data of images increases due to increase in the number of images held by a user and the high image quality of a digital camera, image analysis for image evaluation takes time. Further, time is also taken when image data is transferred to an image processing device. Therefore, a waiting time for the user increases.

An object of the present invention is to shorten a waiting time for the user.

An image evaluation apparatus according to the present invention includes a supplementary information reading unit that reads supplementary information representing a characteristic of an image; an image evaluation process determination unit that determines whether an evaluation process of the image corresponding to the supplementary information read by the supplementary information reading unit is to be performed using the supplementary information; and an image evaluation processing unit that performs the evaluation process of the image according to the image evaluation process determination unit determining that the evaluation process is to be performed.

This invention provides an image evaluation method. That is, in this method, a supplementary information reading unit reads supplementary information representing a characteristic of an image, an image evaluation process determination unit determines whether an evaluation process of the image corresponding to the supplementary information read by the supplementary information reading unit is to be performed using the supplementary information, and an image evaluation processing unit performs the evaluation process of the image according to the image evaluation process determination unit determining that the evaluation process is to be performed.

This invention provides a program for controlling a computer of the image evaluation apparatus, and a recording medium having the program stored therein.

An image file reading unit that reads an image file representing an image on which the evaluation process is determined to be performed by the image evaluation process determination unit may be further included. In this case, the image evaluation processing unit may perform the evaluation process of the image represented by the image file read by the image file reading unit.

An image file reading unit that reads image files (a plurality of image files representing a large number of images that are required to be grouped is necessary) may be further included. In this case, the image evaluation processing unit may perform the evaluation process of an image on the image on which the evaluation process is determined to be performed by the evaluation process determination unit among a plurality of images represented by a plurality of image files read by the image file reading unit.

a grouping unit that groups a plurality of images based on the supplementary information read by the supplementary information reading unit may be further included. In this case, the image evaluation process determination unit, for example, may determine, for each image grouped by the grouping unit, whether the evaluation process of the image having a characteristic of the supplementary information read by the supplementary information reading unit is to be performed using the supplementary information, and the image evaluation processing unit may perform, for example, the evaluation process of an image that is included in a group on which the evaluation process is determined to be performed by the image evaluation process determination unit.

a specifying unit that specifies the group on which the image evaluation process is to be performed among the image groups grouped by the grouping unit may be further included. In this case, the image evaluation process determination unit may determine that the image evaluation process is to be performed on an image in the group specified by the specifying unit.

The supplementary information may be stored in the image file or may be recorded to a file different from the image file or a different medium.

a first display control unit that controls a display device to display the image on which the evaluation process is determined to be performed by the image evaluation process determination unit may be further included.

a second display control unit that controls a display device to display the image of which an evaluation of the image on which the evaluation process is performed by the image evaluation processing unit is equal to or more than a certain value may be further included.

a third display control unit that controls a display device to display, in a page constituting an electronic album, an image of which the image evaluation on which the evaluation process is performed by the image evaluation processing unit is equal to or more than a certain value may be further included.

The supplementary information may be information other than the image data representing the image itself. For example, the supplementary information may be text data or thumbnail image data. However, an amount of data of the supplementary information is less than an amount of data of the image data representing the image itself. The supplementary information of the image may be further used for the image evaluation in the image evaluation processing unit.

The supplementary information reading unit includes, for example, reception unit that receives supplementary information transmitted over a network. In this case, the supplementary information reading unit may read the supplementary information received by the reception unit.

According to the present invention, the supplementary information of the image is read, and it is determined whether the evaluation process of the image corresponding to the read supplementary information is to be performed using the read supplementary information. When the evaluation process is determined to be performed, the evaluation process is performed. Since the evaluation process in the image evaluation processing unit is performed on the image considered to be necessary using the supplementary information without the evaluation process in the image evaluation processing unit being performed on all pieces of image data representing the images, a time until the image evaluation ends is shortened. The waiting time for the user is shortened.

### DESCRIPTION OF THE PREFERRED EMBODIMENTS

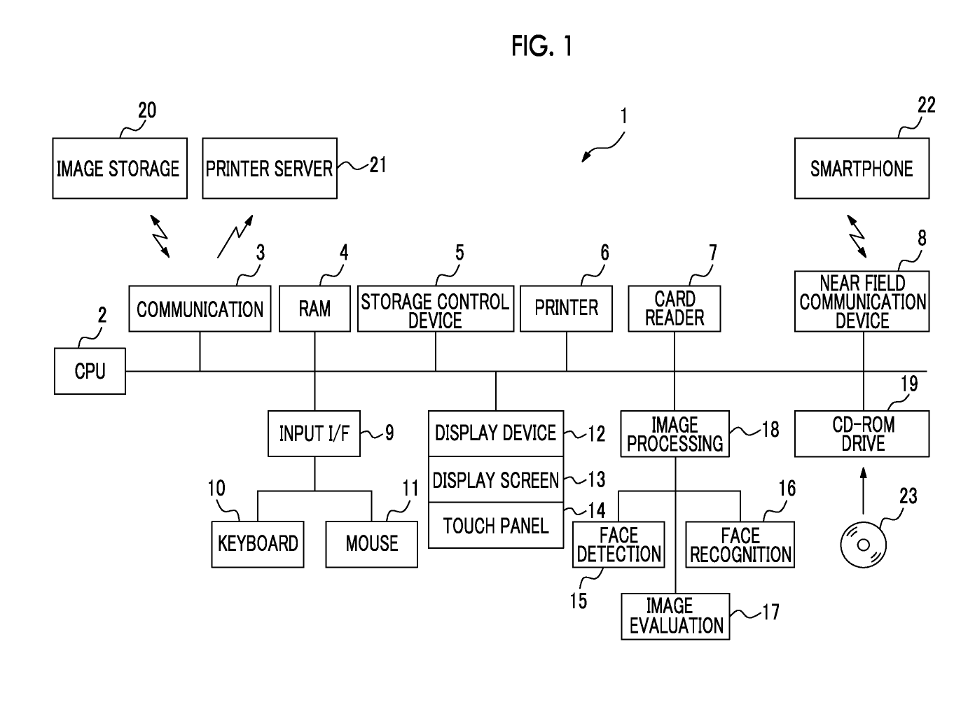

FIG. 1 is a block diagram illustrating an electrical configuration of an electronic album generation device.

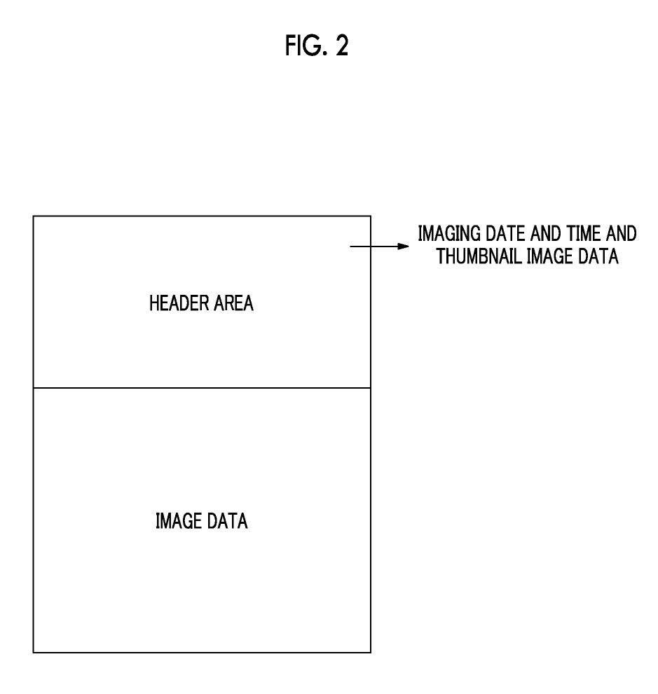

FIG. 2 illustrates a file structure of an image file.

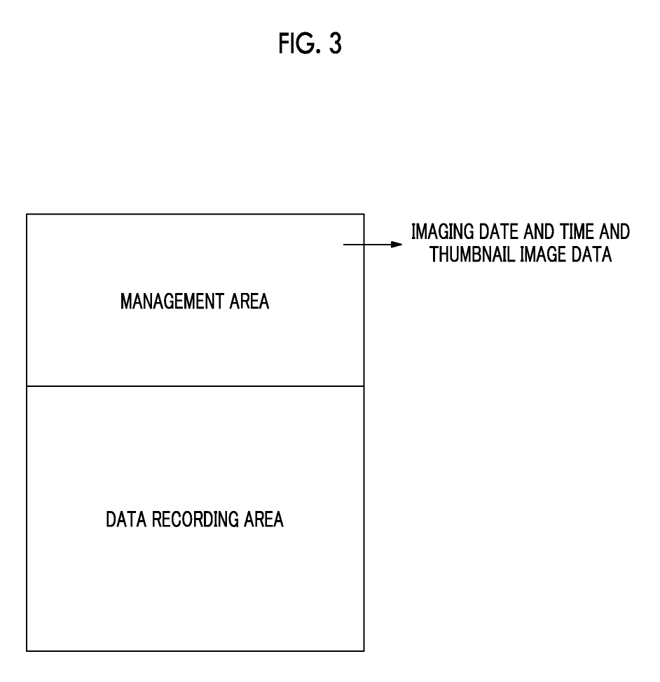

FIG. 3 illustrates a memory structure of a recording medium.

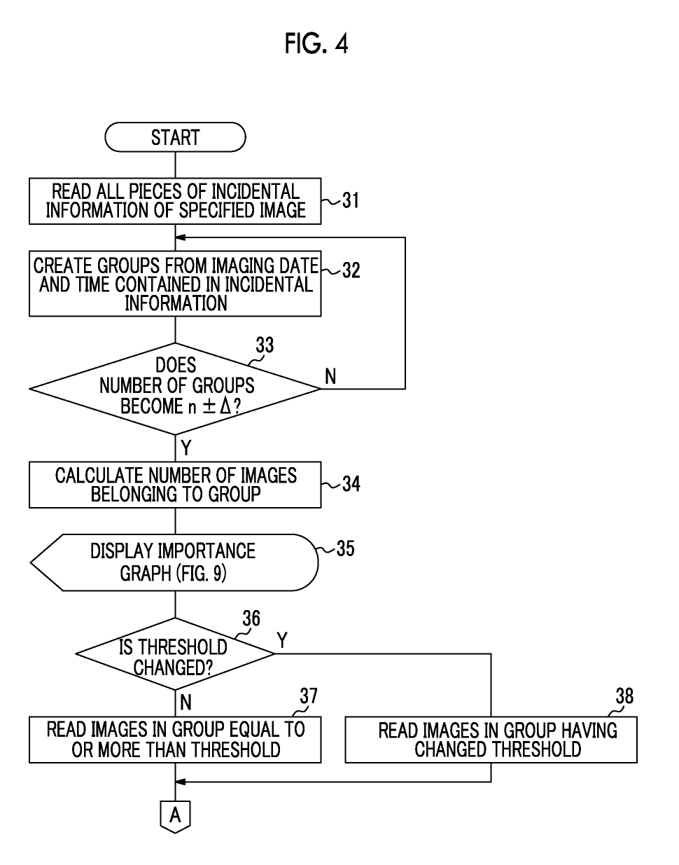

FIG. 4 is a flowchart illustrating a processing procedure of an electronic album generation device.

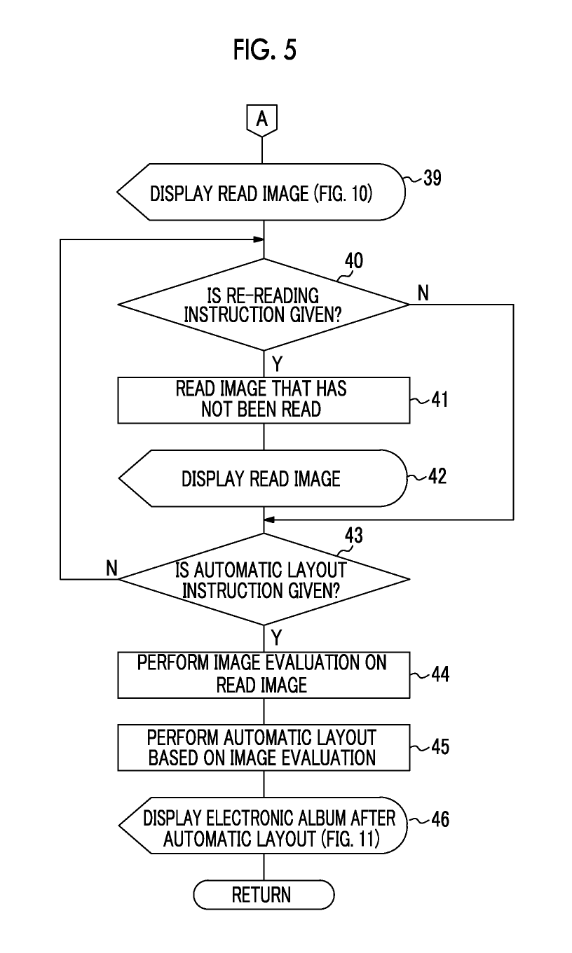

FIG. 5 is a flowchart illustrating a processing procedure of an electronic album generation device.

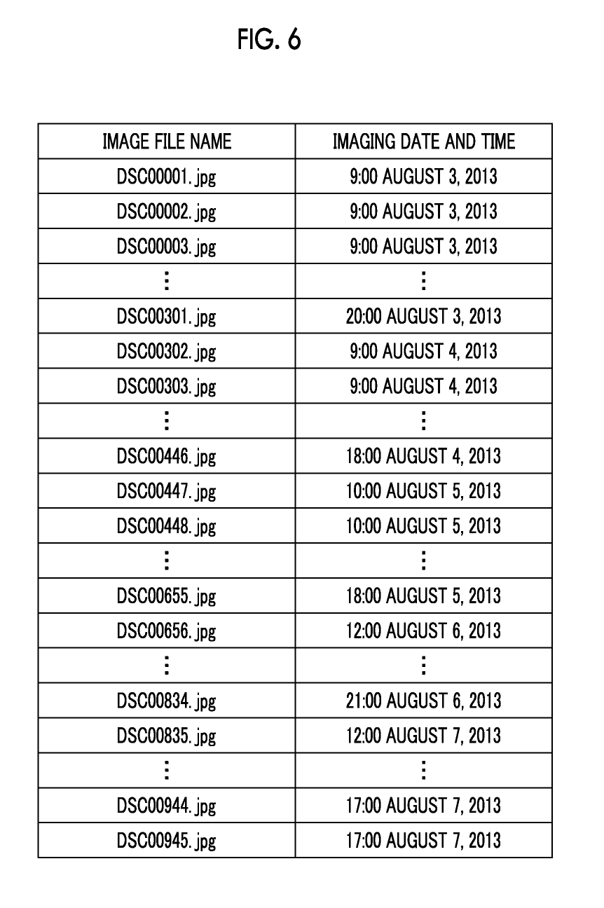

FIG. 6 illustrates an example of an imaging date and time table.

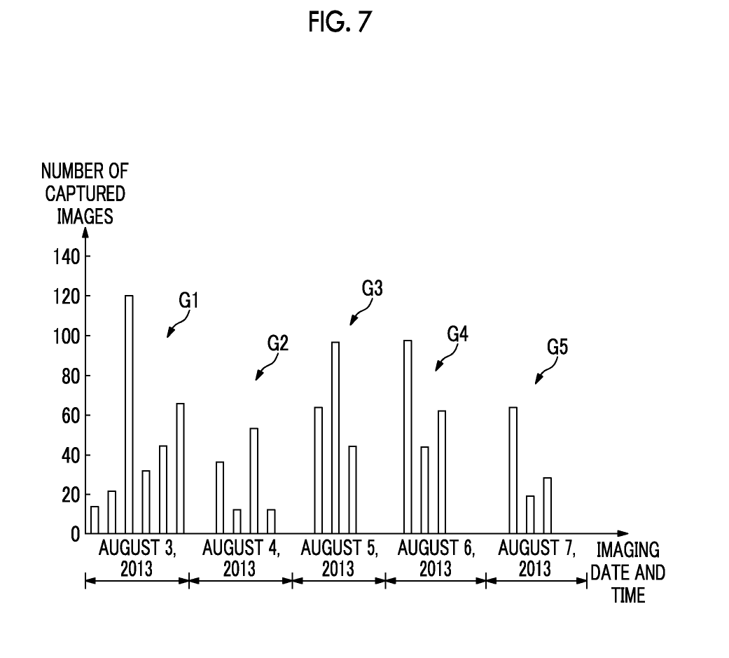

FIG. 7 illustrates a state in which a group is created.

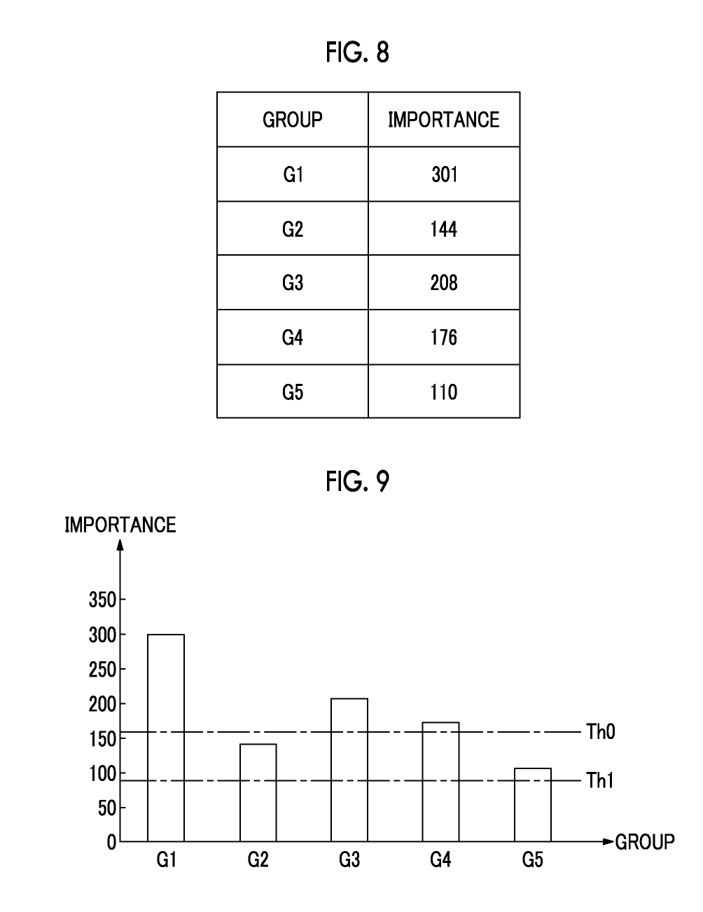

FIG. 8 illustrates an example of an importance table.

FIG. 9 illustrates an example of an importance graph.

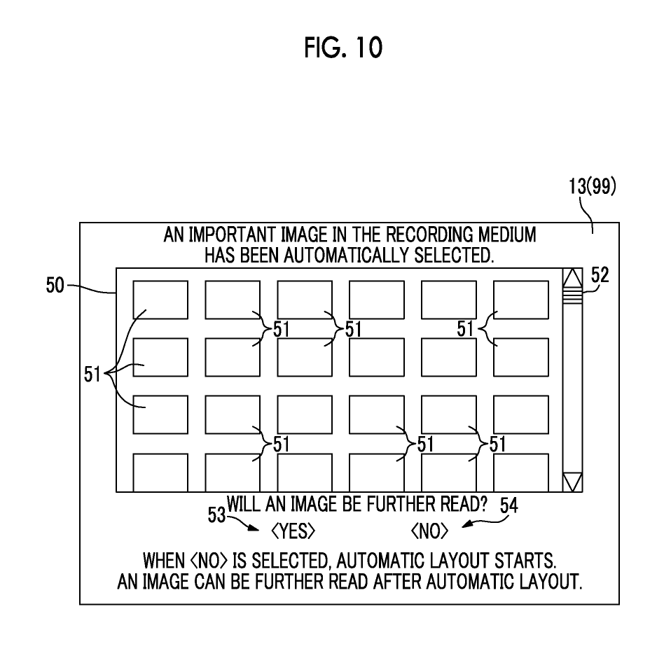

FIG. 10 illustrates an example of a display screen.

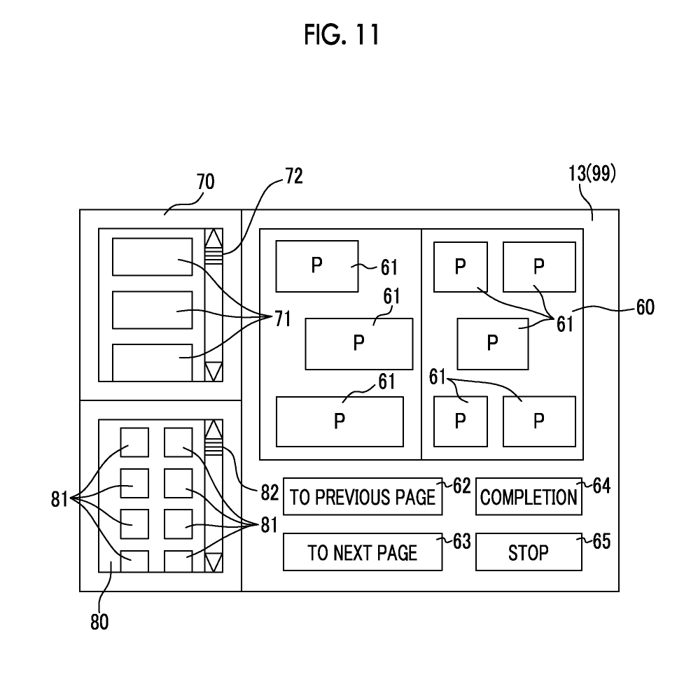

FIG. 11 illustrates an example of a display screen.

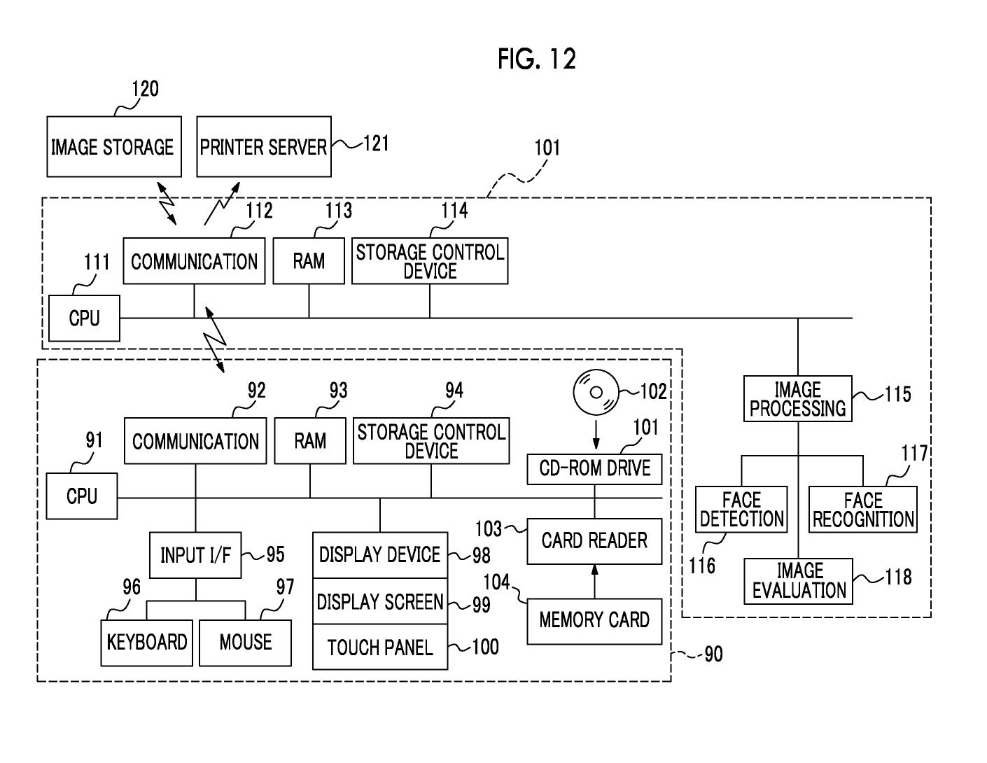

FIG. 12 is a block diagram illustrating an electrical configuration of a personal computer, a server and the like.

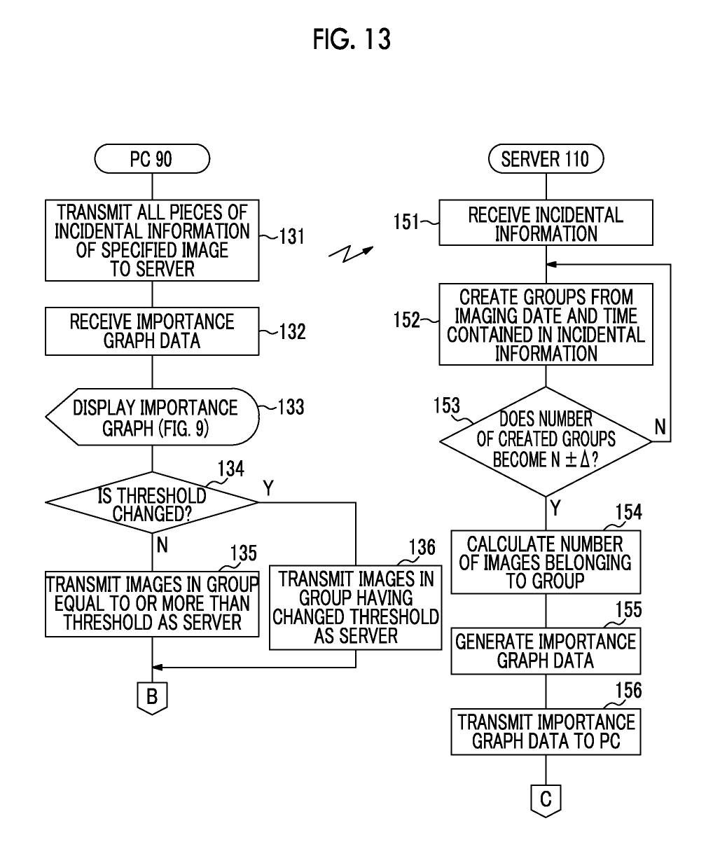

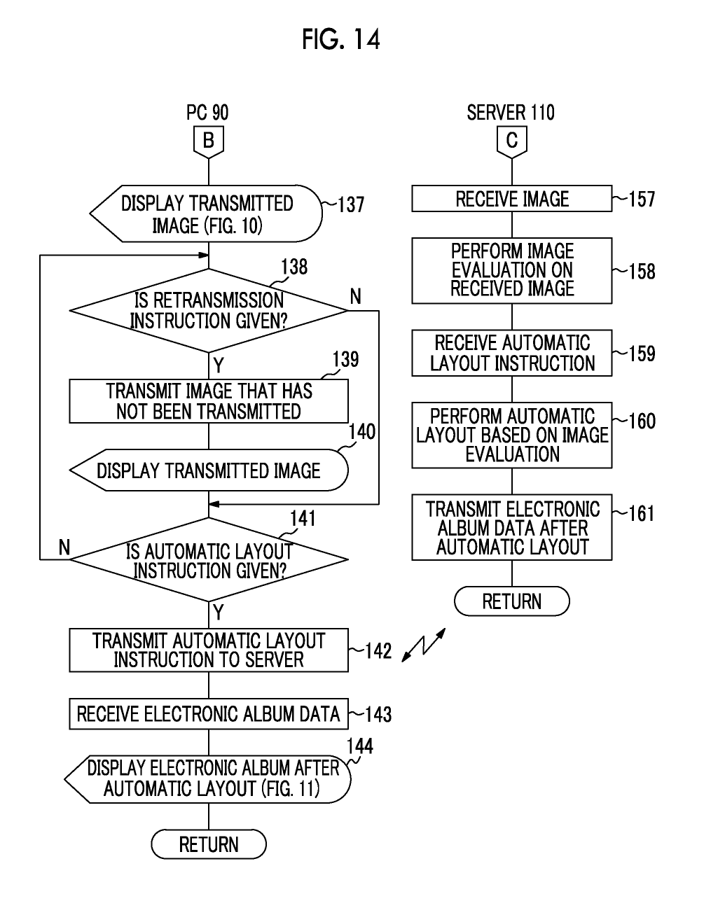

FIG. 13 is a flowchart illustrating a processing procedure of the personal computer and the server.

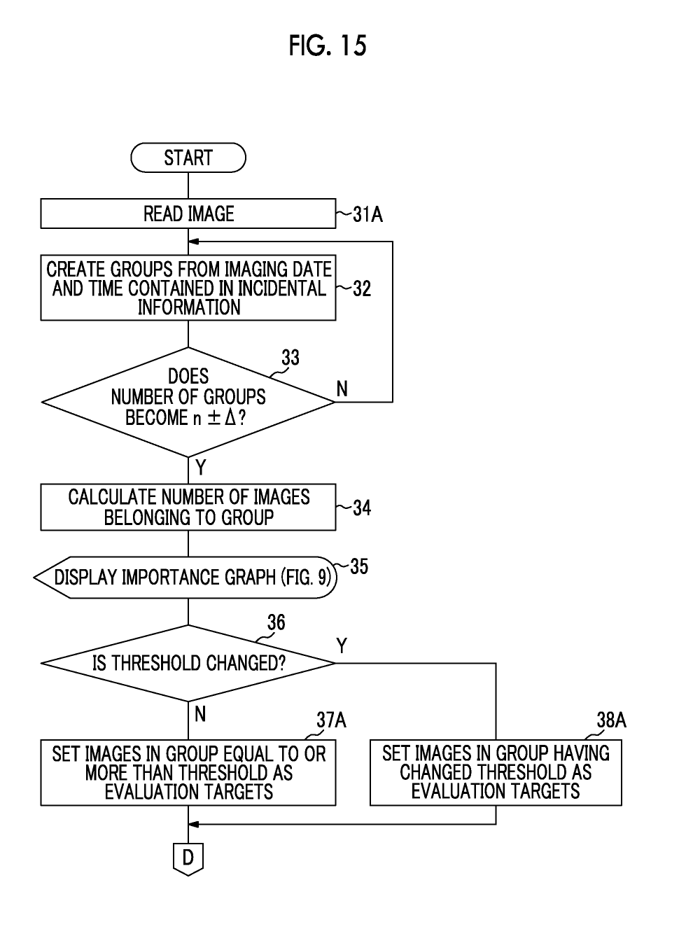

FIG. 14 is a flowchart illustrating a processing procedure of the personal computer and the server.

FIG. 15 is a flowchart illustrating a processing procedure of an electronic album generation device.

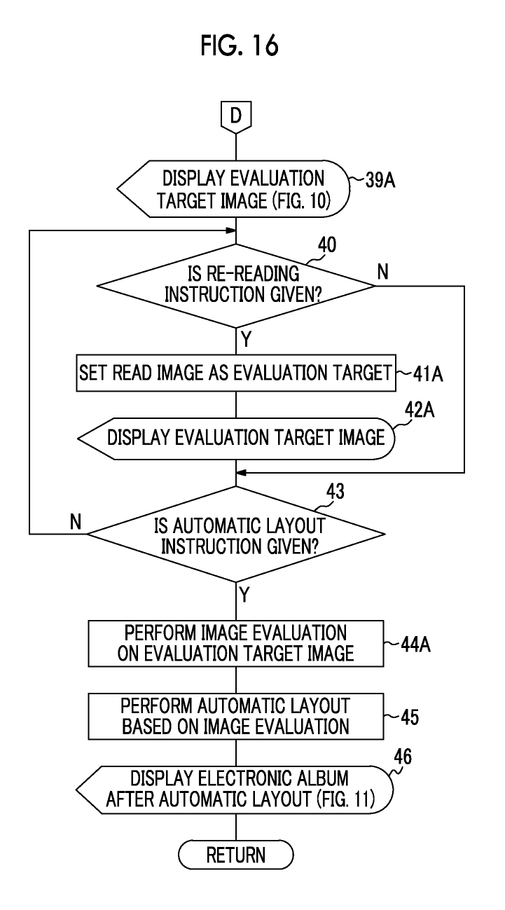

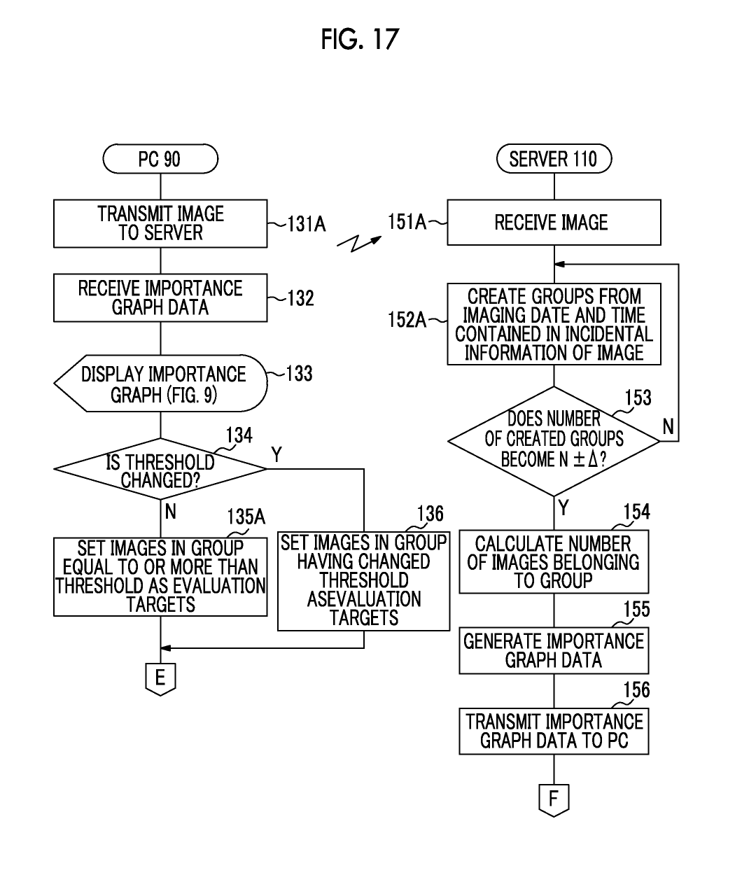

FIG. 16 is a flowchart illustrating a processing procedure of the electronic album generation device.

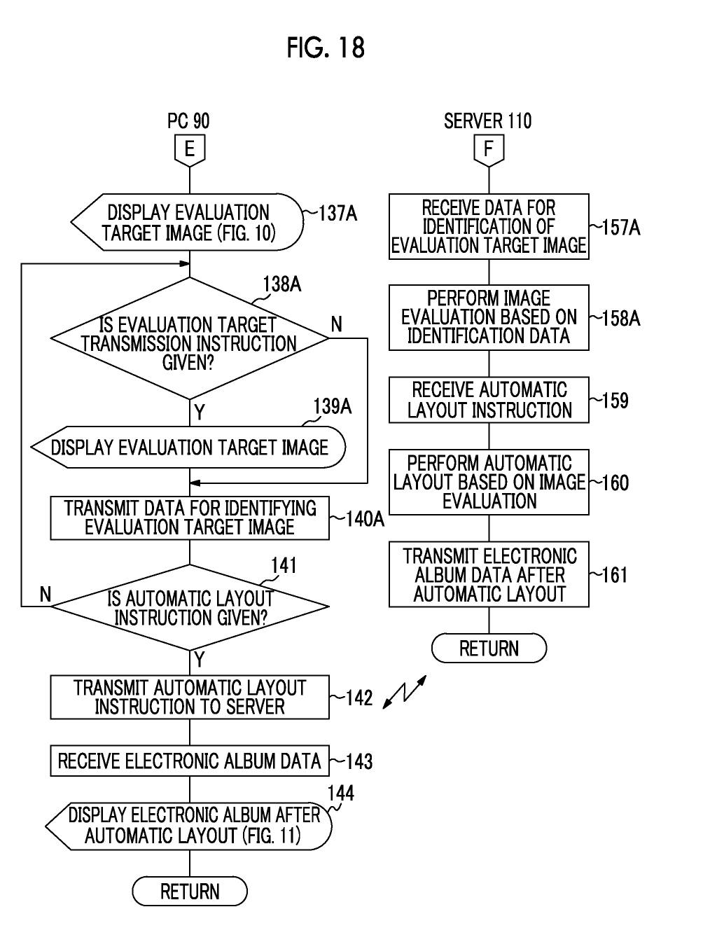

FIG. 17 is a flowchart illustrating a processing procedure of the personal computer and the server.

FIG. 18 is a flowchart illustrating a processing procedure of the personal computer and the server.

### DESCRIPTION OF THE PREFERRED EMBODIMENTS

FIG. 1 is a block diagram illustrating an electrical configuration of an electronic album generation device 1 (an example of an image evaluation apparatus). The electronic album generation device 1 is arranged in a front of a store such as a supermarket or a convenience store.

An entire operation of the electronic album generation device 1 is controlled by a CPU 2. The CPU 2 is an example of an image evaluation process determination unit, a grouping unit, a first display control unit, a second display control unit, or a third display control unit.

The electronic album generation device 1 includes an image storage 20 in which image files are stored, a communication device 3 for communicating with a printer server 21 or the like, a random access memory (RAM) 4 that temporarily stores, for example, data, a storage control device 5 that storage-controls data in the RAM 4, a printer 6, a card reader 7 that reads, for example, data recorded in a memory card, and a near field communication device 8 for communicating with a smartphone 22. The communication device 3, the card reader 7 and the near field communication device 8 are examples of a supplementary information reading unit and image file reading unit.

Further, a keyboard 10, a mouse 11, and an input interface 9 for inputting an instruction from the keyboard 10 or the mouse 11 to the electronic album generation device 1 are included in the electronic album generation device 1. Further, a display device 12, an image processing device 18, and a compact disc-read only memory (CD-ROM) drive 19 (an example of a supplementary information reading unit or an image file reading unit) are included in the electronic album generation device 1. A touch panel 14 is formed in a display screen 13 formed in the display device 12. Further, a face detection device 15, a face recognition device 16, an image analysis device (not illustrated), and an image evaluation apparatus 17 are connected to the image processing device 18. The CPU 2 may perform an image analysis function in the image analysis device.

When the CD-ROM 23 (recording medium) in which an operation program to be described below is stored is loaded into the CD-ROM drive 19, the operation program is read from the CD-ROM 23. The read operation program is installed in the electronic album generation device 1. Accordingly, the electronic album generation device 1 performs an operation to be described below according to the operation program.

A user carries a recording medium such as a memory card, a CD-ROM or a smartphone 22 in which image files representing a large number of captured images such as tens of to thousands of images are recorded. The image files recorded in the carried recording medium are read to the electronic album generation device 1. When the image files of the user are stored in the image storage 20, the electronic album generation device 1 may access the image storage 20 so that the image files may be read to the electronic album generation device 1. An electronic album is created from the read electronic files. If the recording medium carried by the user is the memory card, the image files are read to the electronic album generation device 1 by the card reader 7. When the recording medium is the smartphone 22, the image files are read to the electronic album generation device 1 by the near field communication device 8 and read to the electronic album generation device 1 by the CD-ROM drive 19.

In the electronic album generation device 1 according to this embodiment, the electronic album is created through automatic layout using images for which the image evaluation of the image evaluation apparatus 17 is high among a plurality of images. The image evaluation in the image evaluation apparatus 17 is generally performed in consideration of detection of a face by the face detection device 15, a large size of the detected face, appropriate brightness of the detected face, presence of the detected face at a center of the image, detection of a face of a specific person by the face recognition device 16, an analysis result of images in the image analysis device, such as appropriate brightness, chroma, color, out-of-focus, blur, or composition of the image, or presence or absence of a similar image, and information from the supplementary information. The automatic layout in the electronic album is performed using the images for which the evaluation of the image evaluation apparatus 17 is high.

Particularly, in this embodiment, since the image evaluation in the image evaluation apparatus 17 is not performed on all images stored in the recording medium carried by the user, images on which the image evaluation is to be performed in the image evaluation apparatus 17 are determined based the supplementary information of the image, and the evaluation in the image evaluation apparatus 17 is performed on the determined images, a time required for the image evaluation is shortened.

FIG. 2 is an example of a file structure (data structure) of the image file.

A header area and an image data recording area are included in the image file. The image data representing the image is recorded in the image data recording area. Supplementary information representing a characteristic of the image data recorded in the image data recording area is recorded in the header area. This supplementary information includes, for example, thumbnail image data, in addition to an image file name, imaging date and time, an imaging place, a size of an image, a resolution, a luminance value, chroma, information on a person of a subject such as presence or absence of a face, the number of faces, presence or absence of a person, the number of persons, text data representing a person name, or binary data. The electronic album generation device 1 can read the supplementary information from the header area of the image file.

FIG. 3 is an example of a structure of a memory area of a recording medium such as a memory card, a CD-ROM, or a smartphone.

A management area and a data recording area are included in the memory area. A large number of image files of which the structure is illustrated in FIG. 2 are stored in the data recording area. The supplementary information (an image file name of the image file recorded in the data recording area, imaging date and time, an imaging place, a size of the image, a resolution, a luminance value, chroma, and information on a person of a subject, such as presence or absence of a face, the number of faces, presence or absence of a person, the number of persons, text data representing a person name, binary data, thumbnail image data, or the like) for managing the large number of image files stored in the data recording area may be stored in the management area. In such a case, the supplementary information of a desired image file can be read from the management area included in the memory area of the recording medium.

Further, the supplementary information may be recorded in a recording medium (a recording medium for supplementary information) different from the recording medium (a recording medium for image files) in which the image files are stored. For example, the image files may be recorded in the memory card, and supplementary information of the image files may be recorded in the smartphone 22. The supplementary information of the image files is read from the smartphone, and an image file having an image file name corresponding to the read supplementary information is read from the memory card.

FIGS. 4 and 5 are flowcharts illustrating a processing procedure of the electronic album generation device 1 configured by the CPU 2.

In the processing procedure illustrated in FIGS. 4 and 5, in the electronic album generation device 1, the supplementary information of a specified image is first read without the image file being read, an image file (image file corresponding to the supplementary information) to be read is determined using the supplementary information, and the determined image file is read in the electronic album generation device 1. An image evaluation process is performed on the read image file by the image evaluation apparatus 17, and an electronic album is created using the images of which evaluation is high.

A desired image file is specified from among the image files recorded in the recording medium carried by the user or image files stored in the image storage 20 (the image files are not necessarily specified one by one, and all image files recorded in the recording medium or all image files stored in a specific folder may be specified), and the supplementary information corresponding to the specified image file is read by the electronic album generation device 1 (step 31) (in this case, the electronic album generation device further serves as a supplementary information reading unit). When the recording medium in which the supplementary information is recorded is the image storage 20, the memory card, the smartphone, or the CD-ROM, the supplementary information is read by the communication device 3, the card reader 7, the near field communication device 8 or the CD-ROM drive 19. In this embodiment, since the imaging date and time in the supplementary information is used, only the imaging date and time to be used is read, and other supplementary information may not be read. However, other supplementary information may be read, in addition to the imaging date and time.

When the supplementary information is read, an imaging date and time table is created by the CPU 2 using the imaging date and time contained in the supplementary information.

FIG. 6 is an example of the imaging date and time table.

The imaging date and time table is a table in which an image file name and the imaging date and time are associated.

The supplementary information for the image file specified by the user is read from the recording medium or the image storage 20 carried by the user, and the imaging date and time contained in the supplementary information is stored in the imaging date and time table in association with an image file name corresponding to the supplementary information. The created imaging date and time table is stored in the RAM 4.

For example, when image files having image file names DSC00001.jpg to DSC00945.jpg are specified by the user, the date and time when the images are captured is read from the supplementary information of the image files by the electronic album generation device 1 and stored in the imaging date and time table. Since 301 images from the image file name DSC00001.jpg to DSC00301.jpg, 144 images from the image file names DSC00302.jpg to DSC00446.jpg, 208 images from the image file names DSC00447.jpg to DSC00655.jpg, 178 images from the image file names DSC00656.jpg to DSC00834.jpg, and 110 image file names DSC00835.jpg to DSC00945.jpg are captured on Aug. 3, 2013, Aug. 4, 2013, Aug. 5, 2013, Aug. 6, 2013, and Aug. 7, 2013, respectively, imaging dates and times thereof are stored in the imaging date and time table in association with the image files.

Referring back to FIG. 4, for example, a group is created based on the imaging dates and times read by grouping unit configured by the CPU (step 32).

FIG. 7 illustrates a state in which the group is created.

A horizontal axis of FIG. 7 indicates the imaging date and time, and a vertical axis indicates the number of images.

A setting is performed in advance, for example, so that images captured within 24 hours are grouped in the same group. In this embodiment, 945 images from DSC0001.jpg to DSC00945.jpg are assumed to be captured on Aug. 3, 2013 to Aug. 7, 2013. Then, images captured on Aug. 3, 2013 are in a group G1, images captured on Aug. 4, 2013 are in a group G2, images captured on Aug. 5, 2013 are in a group G3, images captured on Aug. 6, 2013 are in a group G4, and images captured on Aug. 7, 2013 are in a group G5.

Referring back to FIG. 4, it is determined whether the number of created groups has become a prescribed number n±Δ (n and Δ are positive integers; n>Δ) (step 33). If the number of created groups is not the prescribed number n±Δ (NO in step 33), a range of time for the same group is adjusted, and a group is re-created by the CPU 2 so that the number of created groups becomes the prescribed number n±Δ (step 32).

When the number of created groups becomes the prescribed number n±Δ (Yes in step 33), the number of images belonging to each group is calculated by the CPU 2 (step 34). The calculated number of images is an importance of images belonging to each group, and an importance table is created. The created importance table is stored in the RAM 4.

FIG. 8 is an example of the importance table.

A value indicating the importance of each group is stored. The numbers of images belonging to the groups G1, G2, G3, G4 and G5 are 301, 144, 208, 176 and 110 and become the importance of the images belonging to the groups, as described above.

When the numbers of images belonging to the groups are calculated and the importance table is created, an importance graph is displayed on the display screen 13 of the display device 12 (step 35 in FIG. 4).

FIG. 9 is an example of the importance graph.

A horizontal axis of the importance graph indicates the group, and a vertical axis indicates the importance (the number of images belonging to each group).

An initial threshold Th0 is set to determine the importance of the images belonging to the group. In the example illustrated in FIG. 9, the initial threshold Th0 is set at the importance of 160. The images belonging to the group exceeding the threshold are determined to be important images, and become image evaluation targets in the image evaluation apparatus 17.

In this embodiment, when a user traces on the touch panel 14 with a user's finger so that the initial threshold Th0 displayed on the display screen 13 increases or decreases, the threshold increases or decreases according to a movement of the finger. The threshold can be changed from the initial threshold Th0 to a threshold Th1 corresponding to the importance of 80, as illustrated in FIG. 9. Since the number of the groups exceeding the threshold increases when the threshold decreases, the number of the images that become the image evaluation targets increases. On the other hand, since the number of groups exceeding the threshold decreases when the threshold increases, the number of the images that become the image evaluation targets decreases (an example of an operation of the a specifying unit that specifies an image group in an example of a touch panel). The threshold decreases when the number of groups exceeding the threshold is too large, and increases when the number of groups exceeding the threshold is too small.

Referring back to FIG. 4, when the threshold is not changed (NO in step 36), image files representing images belonging to the groups equal to or more than the initial threshold are read from the recording medium (image storage 20) (step 37). When the threshold is changed (YES in step 36), image files representing images belonging to the groups equal to or more than the changed threshold are read from the recording medium (image storage 20) (step 38). Since image file names of the images belonging to the groups equal to or more than the threshold are confirmed from the importance graph illustrated in FIG. 9 and the imaging date and time table illustrated in FIG. 6, the image files are read from the recording medium (image storage 20) in which the image files have been recorded (communication unit 3 functions as image file reading unit). Even when the recording medium in which the supplementary information has been recorded and the recording medium in which the image files have been recorded are different from each other, it is needless to say that the image files representing the images belonging to the groups equal to or more than the threshold are read. The read image files are temporarily stored in the RAM 4. Since the image evaluation to be described below is performed on the images belonging to the groups equal to or more than the threshold, the CPU 2 (an example of the image evaluation process determination unit) determines whether the evaluation process of an image having a characteristic of the supplementary information is to be performed according to whether the images belongs to the group equal to or more than the threshold.

When the image files are read, the images represented by the read image files are displayed as a list on the display screen of the display device 12 (step 39 in FIG. 5) (an operation example of the first display control unit and the second display control unit by the CPU 2).

FIG. 10 is an example of an image list display screen.

An image display area 50 is formed in the display screen 13. Images 51 represented by the image files read as described above are displayed in this image display area 50. A slide bar 52 is displayed on the right side of the image display area 50. When a user traces up and down on this slide bar 52 with a user's finger, images not displayed in the image display area 50 but represented by the read image files are displayed.

A sentence “An important image in the recording medium has been automatically selected.” is displayed in the image display area 50 so as to report to the user that an image considered to be important among the images recorded in, for example, the recording medium carried by the user is displayed. Further, a sentence “Will another image be read?” is displayed under the image display area 50 so as to report to the user that another image can be read. Further, a character string 53 of <YES>, a character string 54 of <NO>, a sentence “When <NO> is selected, automatic layout starts.,” and a sentence “Another image can be read after automatic layout.” are displayed.

When the character string 53 of <YES> is touched by the user (YES in step 40 in FIG. 5), a re-reading instruction is given to the electronic album generation device 1, and an image file that is not read from the recording medium carried by the user is read (step 41 in FIG. 5). All of image files that are not read among the image files recorded in the recording medium carried by the user may be read, or the threshold in the importance graph as illustrated in FIG. 9 may be decreased and image files representing images belonging to the group having importance equal to or more than the decreased threshold may be read from the recording medium. For example, when the character string 53 of <YES> illustrated in FIG. 10 is touched in a state in which the threshold has not changed from the initial threshold Th0, the threshold decreases from the initial threshold Th0 to the threshold Th1. Accordingly, image files representing the images belonging to the groups G2 and G5 which have not been read are read from the recording medium. The images represented by the newly read image files are displayed in the image display area 50.

When the character string 54 of <NO> is touched by the user, the processes of steps 41 and 42 in FIG. 5 are skipped, and an automatic layout instruction is given to the electronic album generation device 1 (step 43 in FIG. 5). Then, the image files read to the electronic album generation device 1 are given to the image evaluation apparatus 17. In the image evaluation apparatus 17, the image evaluation represented by the image file is performed (step 44 in FIG. 5). Since the image files read to the electronic album generation device 1 are determined to be images that are evaluation process targets, the image evaluation process is performed by the image evaluation apparatus 17 (an example of the image evaluation processing unit by the CPU 2) under control of the CPU 2 based on a result of the determination. In the image evaluation, suitability for display in the electronic album is checked using brightness, chroma, color, out-of-focus, blur, composition or the like of the image by the image analysis device, as described above. An image evaluation is high as an image is suitable for the electronic album. The image file is given to the face detection device 15 and it is determined whether a face is included in the image, if necessary. Further, the image file is given to the face recognition device 16, and it is determined whether a face of a specific person is included in the image. The image evaluation can be high for an image in which a face is included or the image in which the face of the specific person is included. In this case, information on a person of a subject, such as presence or absence of a face, the number of faces, presence or absence of a person, the number of persons, or a person name may be given in the supplementary information by a digital camera or a smartphone. However, since the face detection device 15 and the face recognition device 16 of the image evaluation apparatus usually have better performance than digital cameras or smartphones, these processes are performed again in some cases. Further, the supplementary information and the result of the analysis device may be combined to perform the image evaluation. For example, if images are determined to be images captured consecutively from the imaging time information (the imaging date and time) based on the supplementary information, the image evaluation is high, but when it is determined through a face detection process that a face is not included, the image evaluation can be decreased, such that accuracy of the image evaluation can be improved.

The images represented by the image files read to the electronic album generation device 1 are automatically laid out in the electronic album based on the image evaluation in the image evaluation apparatus 17 (step 45 in FIG. 5). The images are laid out in an order of imaging date and time in the electronic album, and the layout is performed automatically so that the images having high evaluations are displayed at a center or a wide area of each page of the electronic album (step 45 in FIG. 5).

When the automatic layout of the electronic album ends, the electronic album is displayed on the display screen 13 of the display device 12 (step 46 in FIG. 5) (an operation example of the third display control unit by the CPU 2).

FIG. 11 is an example of an electronic album display screen.

An electronic album display area 60 is formed in a substantially all of the electronic album display screen. Facing pages constituting the electronic album are displayed in this electronic album display area 60. Images 61 laid out automatically are displayed in the facing pages. An area 62 in which a character string of “To previous page” is displayed, an area 63 in which a character string of “To next page” is displayed, an area 64 in which a character string of “Completion” is displayed, and an area 65 in which a character string of “Stop” is displayed are formed under the electronic album display area 60. When the area 62 is touched, a page before the page of the electronic album displayed in the electronic album display area 60 is displayed in the electronic album display area 60. When the area 63 is touched, a page next after the page of the electronic album displayed in the electronic album display area 60 is displayed in the electronic album display area 60. When the area 64 is touched, the electronic album generation process in the electronic album generation device 1 ends. Electronic album data representing the created electronic album is transmitted to the printer server 21, and an album of a paper medium is created, as necessary. When the area 65 is touched, the electronic album generation process in the electronic album generation device 1 stops.

An electronic album page display area 70 that displays pages 71 different from the pages displayed in the electronic album display area 60 is formed in the upper left of the electronic album display area 60. A slide bar 72 is formed on the right side of the electronic album page display area 70. When the slide bar 72 is moved, pages different from the pages 71 displayed in the electronic album page display area 70 are displayed in the electronic album page display area 70.

An image display area 80 is formed under the electronic album page display area 70. Images 81 represented by the image files read as described above are displayed in the image display area 80. A slide bar 82 is formed on the right side of the image display area 80. When the slide bar 82 is moved, images different from the images displayed in the image display area 80 are displayed in the image display area 80.

In the above-described embodiment, since only the image files representing the images that are image evaluation targets are read to the electronic album generation device 1, a reading time for the image files is shortened. A waiting time for the user is shortened. Further, since image evaluation for images for which image evaluation is considered to be unnecessary is not performed, a time required for image evaluation is shortened.

FIGS. 12 to 14 illustrate another embodiment in which an electronic album is created using a server communicating with a personal computer in, for example, a home of a user.

FIG. 12 is a block diagram illustrating an electrical configuration such as a personal computer, a server, and the like.

A personal computer 90 and a server 110 can communicate with each other over a network such as the Internet.

An entire operation of the personal computer 90 is controlled by a CPU 91.

A communication device 92 for communicating with the server 110, a RAM 93, a storage control device 94, an input interface 95, a keyboard 96, a mouse 97, and a display device 98 are included in the personal computer 90. A touch panel 100 is formed in a display screen 99 of the display device 98.

Further, a CD-ROM drive 101 for accessing a CD-ROM 102 and a card reader 103 for accessing a memory card 104 are included in the personal computer 90. An operation program is stored in the CD-ROM 102, and read by the personal computer 90. An operation to be described below is performed by the read operation program being installed in the personal computer 90.

An entire operation of the server 110 is controlled by a CPU 111. In this embodiment, the CPU 111 functions as an image evaluation process determination unit, a grouping unit, a first display control unit, a second display control unit, and a third display control unit.

A communication device 112 for communicating with the personal computer 90, an image storage 120, and a printer server 121 is included in the server 110. Further, a RAM 113, a storage control device 114, an image processing device 115, a face detection device 116, a face recognition device 117, and an image evaluation apparatus 118 are included in the server 110. The communication device 112 is an example of a supplementary information reading unit and an image file reading unit.

FIGS. 13 and 14 are flowcharts illustrating a processing procedure of the personal computer 90 (CPU 91) and the server 110 (CPU 111).

A user of the personal computer loads the CD-ROM 102, the memory card 104 or the like in which the supplementary information is stored, in the CD-ROM drive 101, the card reader 103 or the like. Then, supplementary information of the image is read from the loaded CD-ROM 102 or the like, as described above. The read supplementary information is transmitted from the personal computer 90 to the server 110 (step 131). The CD-ROM 102 and the card reader 103 are examples of a supplementary information reading unit and an image file reading unit.

When the supplementary information transmitted from the personal computer 90 is received in the server 110 (step 151), a grouping process is performed using the imaging date and time contained in the supplementary information, as described above (step 152). When the number of created groups becomes n±Δ (YES in step 153), the number of images belonging to the groups is calculated (step 154) and importance graph data is generated in the server 110 (step 155). The generated importance graph data is transmitted from the server 110 to the personal computer 90 (step 156).

When the importance graph data transmitted from the server 110 is received in the personal computer 90 (step 132), an importance graph is displayed on the display screen 99 of the personal computer 90, as illustrated in FIG. 9 (step 133). Then, a threshold of the importance graph displayed on the display screen 99 of the personal computer 90 is changed by the user of the personal computer 90, if necessary (step 134). When the threshold is not changed (NO in step 134), the image files representing the images belonging to the groups equal to or more than the threshold are transmitted from the personal computer 90 to the server 110 (step 135). When the threshold is changed (YES in step 134), the image files representing the images belonging to the groups equal to or more than the changed threshold are transmitted from the personal computer 90 to the server 110 (step 136).

The images represented by the image files transmitted to the server 110 are displayed on the display screen 99, as illustrated in FIG. 10 (step 137 in FIG. 14). When the user desires to transmit an image file representing an image other than the images displayed on the display screen 99 to the server 110, the user touches the character string 53 of <YES>. Then, an image retransmission instruction is given to the personal computer 90, and the image file not transmitted to the server 110 is transmitted from the personal computer 90 to the server 110 (step 139). The image represented by the image file newly transmitted to the server 110 is displayed on the display screen 99 (step 140).

When the character string 54 of <NO> is touched by the user of the personal computer 90, the automatic layout instruction is given to the personal computer 90 (YES in step 141), and the automatic layout instruction is transmitted from the personal computer 90 to the server 110 (step 142).

When the image file transmitted from the personal computer 90 is received in the communication device (a reception unit) 112 of the server 110 (step 157), the received image file is given to the image evaluation apparatus 118, and the image evaluation is performed in the image evaluation apparatus 118 (step 158).

When a layout instruction transmitted from the personal computer 90 is received in the server 110 (step 159), the images are automatically laid out in the electronic album based on the image evaluation (step 160). Data representing the electronic album laid out automatically is transmitted from the server 110 to the personal computer 90 (step 161).

When the data representing the electronic album transmitted from the server 110 is received in the personal computer 90 (step 143), the images in the electronic album are displayed on the display screen 99 of the personal computer 90, as illustrated in FIG. 11 (step 144).

In the above-described embodiment, since only the image files representing the images that are image evaluation targets are transmitted to the server 110, transmission time of the image files is shortened.

FIGS. 15 and 16 illustrate a variant example, and are flowcharts illustrating a processing procedure of the electronic album generation device 1 illustrated in FIG. 1. FIGS. 15 and 16 correspond to FIGS. 4 and 5, and processes corresponding to the processes of FIGS. 4 and 5 are denoted with the same reference signs as those of the processes illustrated in FIGS. 4 and 5, and description thereof will be omitted.

In this embodiment, only the supplementary information is not first read by the electronic album generation device 1, but the image files (image data) and supplementary information are read (step 31A). When the supplementary information is stored in the image file as illustrated in FIG. 2, it is not necessarily necessary to read the supplementary information, in addition to the image file. Thereafter, as illustrated in FIG. 4, a group is created from the imaging dates and times contained in the supplementary information, and the importance graph illustrated in FIG. 9 is created (steps 32 to 35).

When the threshold is changed (NO in step 36), for example, a flag is established so that images belonging to the group equal to or more than the threshold are evaluation targets (step 37). Further, when the threshold is changed (YES in step 36), for example, the flag is established so that the images belonging to the group equal to or more than the changed threshold are evaluation targets (step 38A).

The images that are evaluation targets are displayed on the display screen 13 (step 39A in FIG. 16). When the character string 53 of <Yes> is touched as described above, the threshold is decreased, and the number of images that are evaluation targets increases (step 41A in FIG. 16). The evaluation target images, including the images that become new evaluation targets, are displayed on the display screen 13 (step 42A in FIG. 16).

When the character string 54 of <NO> is touched as described above, image evaluation is performed on the evaluation target images in the image evaluation apparatus 17 (step 44A). Automatic layout of the electronic album is performed based on the obtained image evaluation (step 45), and the electronic album after the automatic layout is displayed on the display screen 13 (step 46).

In the above-described embodiment, since only the image files that are image evaluation targets are given to the image evaluation apparatus 17 and the image evaluation is performed, a time required for image evaluation is shortened.

FIGS. 17 and 18 illustrate a still another variant example, and are flowcharts illustrating a processing procedure of the personal computer 90 and the server 110 illustrated in FIG. 12. FIGS. 17 and 18 correspond to FIGS. 13 and 14, and the same processes as processes of FIGS. 13 and 14 are denoted with the same reference signs and description thereof will be omitted.

Only the supplementary information is not first transmitted from the personal computer 90 to the server 110, but the image file (image data) and the supplementary information are transmitted from the personal computer 90 to the server 110 (step 131A). Of course, when the supplementary information is stored in the image file, the supplementary information need not be transmitted separately from the image file from the personal computer 90 to the server 110. When the image file and the supplementary information are received in the server 110 (step 151A), a group is created from the imaging dates and times contained in the supplementary information (step 152A), and importance graph data is generated as described above (steps 153 to 155). When the importance graph data is transmitted from the server 110 to the personal computer 90 (step 156), the importance graph is displayed on the display screen 99 of the personal computer 90 (step 133). When the threshold is not changed by the user of the personal computer 90 (NO in step 134), the images in the group equal to or more than the threshold are the evaluation targets (step 135A), and when the threshold is changed (YES in step 134), the images in the group equal to or more than the changed threshold are the evaluation targets (step 136A). The evaluation target images are displayed on the display screen 99 as described above (step 137A in FIG. 18). Further, when the character string 53 of <YES> is touched, an evaluation target transmission instruction is given to the personal computer 90 (YES in step 138A), and a new evaluation target image is newly displayed on the display screen 99 (step 139A). Data (for example, the image file name) for identifying the image that is the new evaluation target is transmitted from the personal computer 90 to the server 110 (step 140A). Further, when an automatic layout instruction is given to the personal computer 90 (YES in step 141), the automatic layout instruction is transmitted from the personal computer 90 to the server 110, as well (step 142).

When the data for identification of the evaluation target image transmitted from the personal computer 90 is received in the server 110 (step 157A), an image file identified by the identification data among the image files already received in the server 110 is given to the image evaluation apparatus 17, and image evaluation is performed (step 158A). Thereafter, when the automatic layout instruction transmitted from the personal computer 90 is received in the server 110 (step 159), automatic layout of the electronic album is performed based on the image evaluation (step 160). The data representing the electronic album laid out automatically are transmitted from the server 110 to the personal computer 90 (step 161).

When the data representing the electronic album is received in the personal computer 90, the electronic album is displayed on the display screen 99 (steps 143 and 144).

In the above-described embodiment, since all image files are not given to the image evaluation apparatus 17, and only image files considered to be important are given to the image evaluation apparatus 17 and image evaluation is performed, the time required for image evaluation can be shortened.

In the above-described embodiment, while the importance graph illustrated in FIG. 9 is displayed, the importance graph may not necessarily be displayed. In this case, the user does not directly change the threshold, but the threshold decreases according to the character string 53 of <YES> being touched by the user as illustrated in FIG. 10.

In the above-described embodiment, while the imaging date and time is used as the supplementary information, the importance of the image can be determined using supplementary information such as global positioning system (GPS) information, color information, information on a person of a subject such as presence or absence of a face, the number of faces, presence or absence of a person, and the number of persons, or a thumbnail image, in addition to the imaging date and time. When the GPS information is used, images captured in a certain range of imaging places can be grouped and the importance of the images belonging to the group can be determined based on the number of images belonging to the group, as in the case of the imaging date and time. The importance determined here may be reflected in the image evaluation in the image evaluation apparatus. For example, in individual image evaluation results, even when images are images having the same evaluation, the images belonging to the group determined to have high importance have a higher image evaluation. Further, the importance of an image in which a person is determined to be photographed can be high or only an image in which the person is photographed can be determined to be important, and the number of faces of persons can be used for importance of images belonging to the group. For example, a group including a large number of images in which a face of a specific person is photographed has high group importance and, as a result, the importance of an image belonging to the group but not including the face is also high. Further, the importance of respective images may be determined without being necessarily grouped, and the electronic album generation device 1 may read only images considered to be important and transmit the images to the server 110 or may give the images to the image evaluation apparatus 17.

What is claimed is:

1. An image evaluation apparatus comprising:
a supplementary information reading unit that reads supplementary information representing a characteristic of an image;
an image evaluation process determination unit that determines whether an evaluation process of the image corresponding to the supplementary information read by the supplementary information reading unit is to be performed using the supplementary information; and
an image evaluation processing unit that performs the evaluation process of the image according to the image evaluation process determination unit determining that the evaluation process is to be performed.

2. The image evaluation apparatus according to claim 1, further comprising:
an image file reading unit that reads an image file representing an image on which the evaluation process is determined to be performed by the image evaluation process determination unit,
wherein the image evaluation processing unit performs the evaluation process of the image represented by the image file read by the image file reading unit.

3. The image evaluation apparatus according to claim 1, further comprising:
an image file reading unit that reads image files,
wherein the image evaluation processing unit performs the evaluation process of an image on the image on which the evaluation process is determined to be performed by the evaluation process determination unit among a plurality of images represented by a plurality of image files read by the image file reading unit.

4. The image evaluation apparatus according to claim 1, further comprising:
a grouping unit that groups a plurality of images based on the supplementary information read by the supplementary information reading unit,
wherein the image evaluation process determination unit determines, for each image grouped by the grouping unit, whether the evaluation process of the image having a characteristic of the supplementary information read by the supplementary information reading unit is to be performed using the supplementary information, and
the image evaluation processing unit performs the evaluation process of an image that is included in a group on which the evaluation process is determined to be performed by the image evaluation process determination unit.

5. The image evaluation apparatus according to claim 2, further comprising:
a grouping unit that groups a plurality of images based on the supplementary information read by the supplementary information reading unit,
wherein the image evaluation process determination unit determines, for each image grouped by the grouping unit, whether the evaluation process of the image having a characteristic of the supplementary information read by the supplementary information reading unit is to be performed using the supplementary information, and
the image evaluation processing unit performs the evaluation process of the image included in a group on which the evaluation process is determined to be performed by the image evaluation process determination unit.

6. The image evaluation apparatus according to claim 3, further comprising:
a grouping unit that groups a plurality of images based on the supplementary information read by the supplementary information reading unit,
wherein the image evaluation process determination unit determines, for each image grouped by the grouping unit, whether the evaluation process of the image having a characteristic of the supplementary information read by the supplementary information reading unit is to be performed using the supplementary information, and
the image evaluation processing unit performs the evaluation process of the image included in a group on which the evaluation process is determined to be performed by the image evaluation process determination unit.

7. The image evaluation apparatus according to claim 4, further comprising:
a specifying unit that specifies the group on which the image evaluation process is to be performed among the image groups grouped by the grouping unit,
wherein the image evaluation process determination unit determines that the image evaluation process is to be performed on an image in the group specified by the specifying unit.

8. The image evaluation apparatus according to claim 2,
wherein the supplementary information is stored in the image file or recorded to a file different from the image file or a different medium.

9. The image evaluation apparatus according to claim 3,
wherein the supplementary information is stored in the image file or recorded to a file different from the image file or a different medium.

10. The image evaluation apparatus according to claim 4,
wherein the supplementary information is stored in the image file or recorded to a file different from the image file or a different medium.

11. The image evaluation apparatus according to claim 7,
wherein the supplementary information is stored in an image file or recorded in a file different from the image file or a different medium.

12. The image evaluation apparatus according to claim 1, further comprising:
a first display control unit that controls a display device to display the image on which the evaluation process is determined to be performed by the image evaluation process determination unit.

13. The image evaluation apparatus according to claim 2, further comprising:
a first display control unit that controls a display device to display the image on which the evaluation process is determined to be performed by the image evaluation process determination unit.

14. The image evaluation apparatus according to claim 1, further comprising:
a second display control unit that controls a display device to display the image of which an evaluation of the image on which the evaluation process is performed by the image evaluation processing unit is equal to or more than a certain value.

15. The image evaluation apparatus according to claim 1, further comprising:
a third display control unit that controls a display device to display, in a page constituting an electronic album, an image of which the image evaluation on which the evaluation process is performed by the image evaluation processing unit is equal to or more than a certain value.

16. The image evaluation apparatus according to claim 1,
wherein the supplementary information is text data or thumbnail image data.

17. The image evaluation apparatus according to claim 1,
wherein the supplementary information of the image is further used for the image evaluation in the image evaluation processing unit.

18. The image evaluation apparatus according to claim 1,
wherein the supplementary information reading unit
includes a reception unit that receives supplementary information transmitted over a network, and
reads the supplementary information received by the reception unit.

19. An image evaluation method using a computer, the method comprising the steps of:
reading supplementary information representing a characteristic of an image using a supplementary information reading unit;
determining whether an evaluation process of the image corresponding to the supplementary information read by the supplementary information reading unit is to be performed using the supplementary information, using an image evaluation process determination unit; and
performing the evaluation process of the image according to the image evaluation process determination unit determining that the evaluation process is to be performed, using an image evaluation processing unit.

20. A non-transient recording medium in which a computer-readable program controlling a computer of an image evaluation apparatus is stored, the program causing the computer of the image evaluation apparatus to execute:
reading supplementary information representing a characteristic of an image;
determining whether an evaluation process of the image corresponding to the read supplementary information is to be performed using the supplementary information; and
performing the evaluation process of the image according to the evaluation process being determined to be performed.
